(19) United States
(12) Patent Application Publication
(10) Pub. No.: US 2016/0124547 A1
(43) Pub. Date: May 5, 2016

(54) TOUCH PROJECTION SCREEN AND PROJECTION SYSTEM USING THE SAME

(71) Applicant: Coretronic Corporation, Hsin-Chu (TW)

(72) Inventor: NAN-JIUN YIN, Hsin-Chu (TW)

(73) Assignee: CORETRONIC CORPORATION, Hsin-Chu (TW)

(21) Appl. No.: 14/797,017

(22) Filed: Jul. 10, 2015

(30) Foreign Application Priority Data
Oct. 30, 2014 (CN) 201410596372.5

(51) Int. Cl. G06F 3/044

(52) U.S. Cl. CPC G06F 3/044; G06F 2203/04112; G06F 2203/04111

(57) ABSTRACT

A touch projection screen includes a capacitive touch sensing layer and a substrate. The capacitive touch sensing layer includes a first surface, a second surface opposite to the first surface, a plurality of first sensing wires, a plurality of second sensing wires and a circuit connection unit. The substrate covers on the first surface. Any two of the first sensing wires don't intersect with each other. Any two of the second sensing wires don't intersect with each other. The first and second sensing wires are alternatively arranged in grid to define a touch sensing area and an edge area is around at least part of the touch sensing area. Each of the first and second sensing wires includes a wire and an insulating layer covering the part of the wire located in the touch sensing area. The circuit connection unit is electrically connected to the wires in the edge area.

### FIELD OF THE INVENTION

The present invention relates to a projection screen, and more particularly to a touch projection screen and a projection system using the same.

### BACKGROUND OF THE INVENTION

In accordance with sensing ways, touch panels mainly can be divided into capacitive touch panel, resistive touch panel, infrared touch panel, electromagnetic induction touch panel and acoustic touch panel. For the capacitive touch panel, a capacitive sensing is formed by a touch between the transparent electrode of indium tin oxide (ITO) in the panel and a human finger or conductive objects. Coordinate data which is used for an operation system to determine the touch point is generated by a computation of a control chip. Patents or patent application publications relating to the capacitive touch panel have been disclosed, such as China Patent Publication NO. 104007885, China Utility Model Patent NO. 201548944, and U.S. Pat. No. 8,237,071.

The conventional capacitive touch panel can be divided into double-board capacitive touch panel and single-board capacitive touch panel. FIG. 1A is a schematic structural side view of a conventional double-board capacitive touch panel. Please refer to FIG. 1A. The conventional double-board capacitive touch panel 10 includes a first board 11, a second board 12, a first sensing electrode layer 13, a second sensing electrode layer 14 and an adhesive 15. The first sensing electrode layer 13 and the second sensing electrode layer 14 are placed on the first board 11 and the second board 12, respectively. The adhesive 15 is provided between the first sensing electrode layer 13 and the second board 12 to adhere the first board 11 and the second board 12 with each other. Because the first sensing electrode layer 13 and the second sensing electrode layer 14 are separated from each other by the second board 12, short circuits are prevented from occurring between the first sensing electrode layer 13 and the second sensing electrode layer 14.

FIG. 1B is a schematic structural side view of a conventional single-board capacitive touch panel. Please refer to FIG. 1B. The conventional single-board capacitive touch panel 20 includes a board 21, a third sensing electrode layer 22, a fourth sensing electrode layer 23 and an insulating layer 24. The third sensing electrode layer 22 is placed on the board 21. The insulating layer 24 is formed between the third sensing electrode layer 22 and fourth sensing electrode layer 23 to prevent short circuits between the third sensing electrode layer 22 and fourth sensing electrode layer 23.

However, when touch function is applied to a projection screen, the touch sensing range of the projection screen is relatively large so that the sensing wire on the two electrode layers of the capacitive touch panel has to be lengthened. Consequentially, the impedance of the sensing wire increases and the responding speed and sensitivity of the projection screen are affected. In additional, the manufacture of the conventional capacitive touch panel requires the embossing, alignment and bonding processes, and any error in these manufacturing processes may cause a low yield. Furthermore, because the touch panel used for a projection screen must have a relatively-large touch sensing area, the size of the manufacturing equipment for producing the capacitive touch panel correspondingly increases and the material cost for producing the capacitive touch panel also increases.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention was acknowledged by a person of ordinary skill in the art.

### SUMMARY OF THE INVENTION

The present invention provides a touch projection screen having less manufacturing process and lower manufacturing cost.

The present invention further provides a projection system using the aforementioned touch projection screen and accordingly having less manufacturing process and lower manufacturing cost.

Other objects and advantages of the invention may be further illustrated by the technical features broadly embodied and described as follows.

To achieve one or a portion of or all of the objects or other objects, one embodiment of the invention provides a touch projection screen includes a capacitive touch sensing layer and a substrate. The capacitive touch sensing layer includes a first surface, a second surface opposite to the first surface, a plurality of first sensing wires, a plurality of second sensing wires and at least one circuit connection unit. The substrate covers on the first surface. Any two of the first sensing wires do not intersect with each other. Any two of the second sensing wires do not intersect with each other. The first sensing wires and the second sensing wires are alternatively arranged in grid to define a touch sensing area and an edge area is around at least part of the touch sensing area. Each of the first sensing wires and the second sensing wires includes a wire and an insulating layer. The insulating layer covers on the part of the wire located in the touch sensing area. The at least one circuit connection unit is electrically connected to the wires in the edge area.

In one embodiment of the invention, the capacitive touch sensing layer further includes a plurality of first insulating wires and a plurality of second insulating wires. The first insulating wires are parallel to the first sensing wires and the second insulating wires are parallel to the second sensing wires. Each of the first insulating wires is disposed between the respective two neighboring first sensing wires, and each of the second insulating wires is disposed between the respective two neighboring second sensing wires. The first insulating wires, the second insulating wires, the first sensing wires, and the second sensing wires are alternatively arranged in grid.

In one embodiment of the invention, each connection unit includes at least one first circuit board which is electrically connected to the first sensing wires, and at least one second circuit board which is electrically connected to the second sensing wires.

In one embodiment of the invention, each of the first circuit board and the second circuit board includes a plurality of connection pads and a connection terminal. A first end of each connection pad is electrically connected to the respective neighboring wires and a second end thereof is electrically connected to the respective connection terminal.

In one embodiment of the invention, the substrate is a white reflection sheet.

In one embodiment of the invention, the substrate further includes a glue layer attached to the first surface of the capacitive touch sensing layer.

In one embodiment of the invention, the touch projection screen further includes a protection layer covering the second surface of the capacitive touch sensing layer.

In one embodiment of the invention, the touch projection screen further includes a translucent layer or a transparent layer covering on a surface of the substrate opposite to the capacitive touch sensing layer.

In one embodiment of the invention, the touch projection screen further includes a case at least covering the edge area of the capacitive touch sensing layer, the circuit connection unit and a part of the substrate.

In one embodiment of the invention, the capacitive touch sensing layer and the substrate are flexible.

To achieve one or a portion of or all of the objects or other objects, one embodiment of the invention provides a projection system which includes the aforementioned touch projection screen and a projection device. The projection device is configured to project an image onto the touch projection screen.

In summary, the first sensing wires and the second sensing wires are arranged in grid in the capacitive touch sensing layer of the touch projection screen and the wires of the first sensing wires and the second sensing wires located in the touch sensing area are coated by the insulating layers; thus, the short circuits are avoided between the first sensing wires and the second sensing wires. Compared with the conventional capacitive touch panel, the touch projection screen of the present invention does not need the embossing, alignment and bonding processes which are used in the conventional capacitive touch panel and accordingly has less manufacturing process. Furthermore, compared with the conventional capacitive touch panel by using the ITO circuits, the touch projection screen of the present invention by using wires coated with insulating layers has lower cost. Thus, the projection system of the present invention has less manufacturing process and lower cost by using the aforementioned touch projection screen.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic structural side view of a conventional double-board capacitive touch panel;

FIG. 1B is a schematic side view of a conventional single-board capacitive touch panel;

FIG. 2 is a schematic view of a projection system in accordance with an embodiment of the invention;

FIG. 3 is a schematic top view of a part of a capacitive touch sensing layer of a touch projection screen in accordance with an embodiment of the invention;

FIG. 4 is a schematic side view of a touch projection screen in accordance with an embodiment of the invention;

FIG. 5 is an enlarged schematic view of a part of a touch sensing area of a capacitive touch sensing layer in accordance with an embodiment of the invention;

FIG. 6 is a schematic view of a first sensing wire in accordance with an embodiment of the invention;

FIG. 7 is a schematic view for illustrating a connection between a circuit connection unit and wires in accordance with an embodiment of the invention;

FIG. 8 is an enlarged schematic view of a part of a touch sensing area of a capacitive touch sensing layer in accordance with another embodiment of the invention; and

FIG. 9 is a cross-sectional view of a touch projection screen in accordance with another embodiment of the invention.

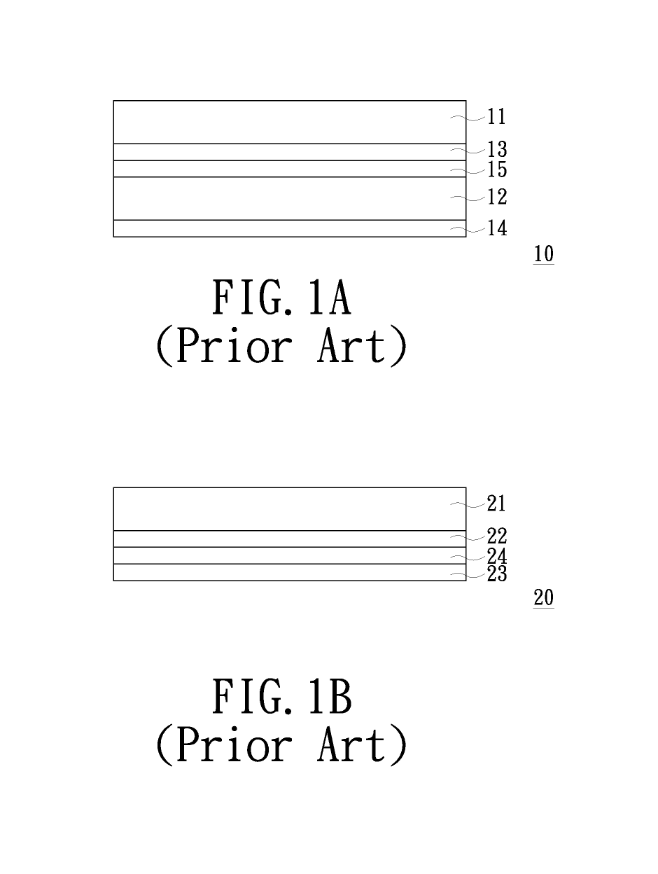

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

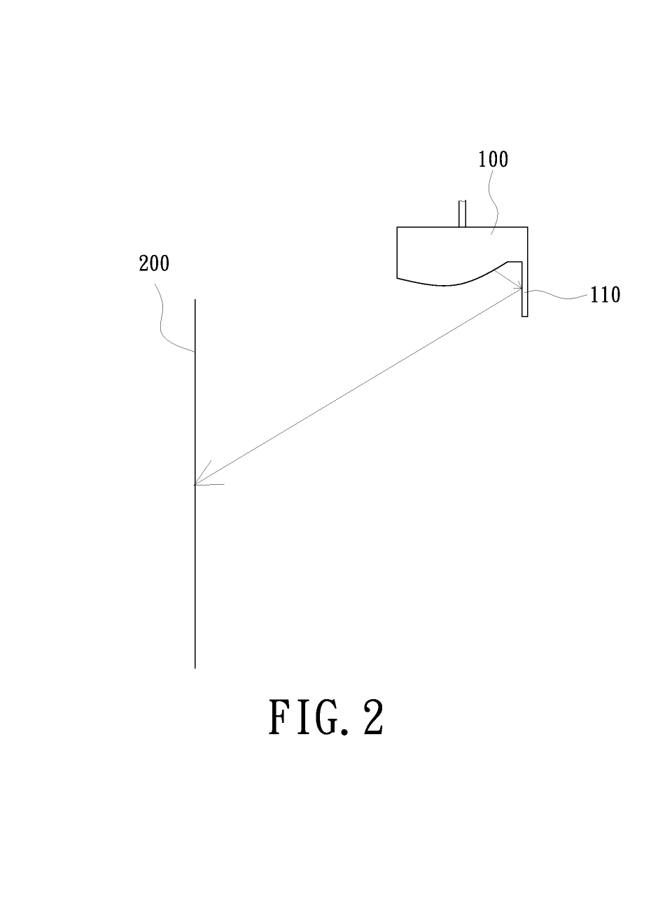

FIG. 2 is a schematic view of a projection system in accordance with an embodiment of the present invention. Please refer to FIG. 2. The projection system in the present embodiment includes a projection device 100 and a touch projection screen 200. The projection device 100 is, for instance, a reflective projector. A reflective projector herein is referred to as a direct projector equipped with a reflection mirror 110 in front of a projection lens thereof for reflecting an image beam thereby projecting a projection image onto the projection screen through one reflection. Because the reflective projector can reflect image beam in a relatively short distance thereby projecting an image on the touch projection screen 200, therefore, the distance between the projection device 100 and the touch projection screen 200 is reduced and consequentially the image projected on the touch projection screen 200 is prevented from being disturbed by shadows of other objects or dist. It is understood that the projection device 100 may be a direct projector in accordance with different requirements, and the present invention is not limited thereto. In other words, the projection device 100 may directly project an image onto the touch projection screen 200 so that a user can touch the touch projection screen 200 for a touch operation.

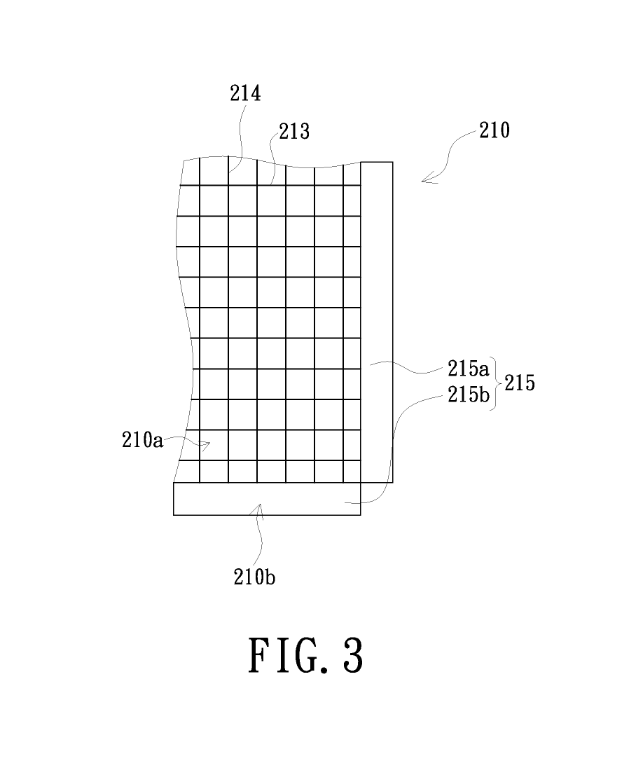

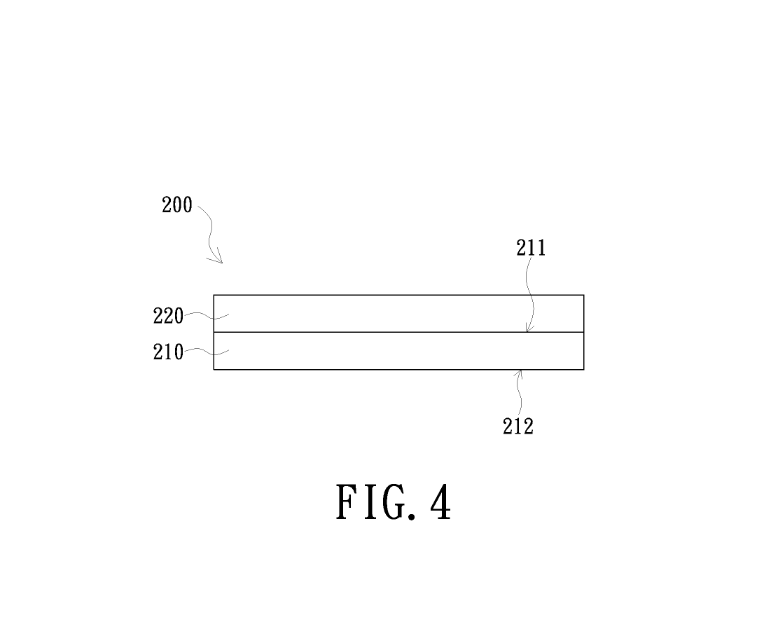

FIG. 3 is a schematic top view of a part of a capacitive touch sensing layer of a touch projection screen in accordance with an embodiment of the present invention. FIG. 4 is a schematic side view of a touch projection screen in accordance with an embodiment of the present invention. Please refer to FIGS. 3 and 4. The touch projection screen 200 in this embodiment includes a capacitive touch sensing layer 210 and a substrate 220. The capacitive touch sensing layer 210 has a first surface 211 and a second surface 212 opposite to the first surface 211. The substrate 220 covers on the first surface 211 of the capacitive touch sensing layer 210. In this embodiment, the substrate 220 is, for instance, a white reflection sheet. Therefore, the projection image can be displayed on the substrate 220 when the image beam projected onto the substrate 220. However, the substrate 220 may be a reflection sheet with other colors in accordance with different requirements, and the present invention is not limited thereto.

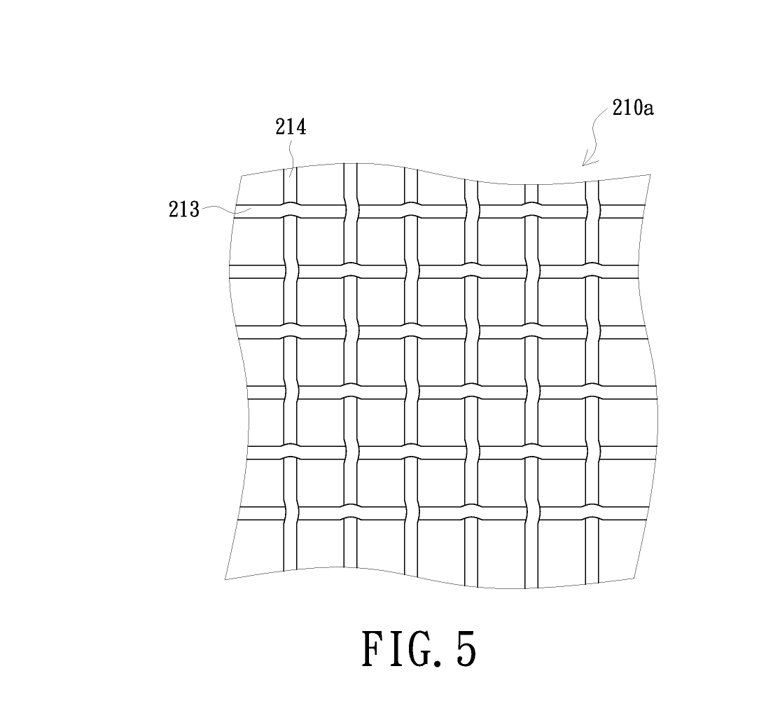

FIG. 5 is an enlarged schematic view of a part of a touch sensing area of a capacitive touch sensing layer in accordance with an embodiment of the invention. Please refer to FIGS. 3 and 5. In this embodiment, the capacitive touch sensing layer 210 includes a plurality of first sensing wires 213, a plurality of second sensing wires 214 and at least one circuit connection unit 215. In one embodiment, the first sensing wires 213 are parallel to each other, and the second sensing wires 214 are parallel to each other. Any two of the first sensing wires 213 do not intersect with each other and any two of the second sensing wires 214 do not intersect with each other. The first sensing wires 213 and the second sensing wires 214 are alternatively arranged in grid to define a touch sensing area 210a and an edge area 210b that is around at least a part of the touch sensing area 210a. In one embodiment, each second sensing wire 214 weaves with the first sensing wires 213 alternatively in an up-and-down manner and each first sensing wire 213 weaves with the second sensing wires 214 alternatively in an up-and-down manner. The first sensing wires 213 and the second sensing wires 214 weave with each other alternatively and are arranged in grid.

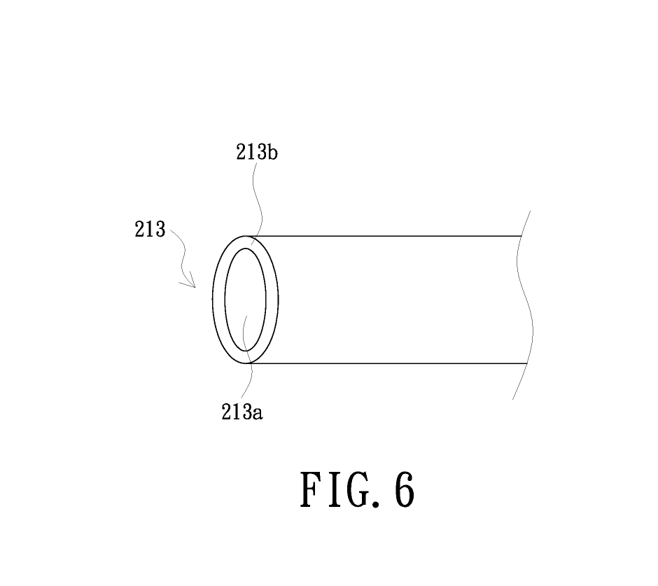

FIG. 6 is a schematic view of a first sensing wire in accordance with an embodiment of the invention. Please refer to FIGS. 3 and 6. In this embodiment, the first sensing wire 213 is taken as an example, and the first sensing wires 213 and the second sensing wires 214 have similar structures. Each first sensing wire 213 includes a wire 213a and an insulating layer 213b which wraps the part of the wire 213a located in the touch sensing area 210a. Thus, the first sensing wires 213 and the second sensing wires 214 are fully insulated in the touch sensing area 210a so as to prevent short circuits from occurring between the first sensing wires 213 and the second sensing wires 214 in the touch sensing area 210a. In this embodiment, the first sensing wires 213 and the second sensing wires 214 are, for instance, enamel insulated wires, that is, the insulating layer 213b is made of insulating paint; however, the present invention is not limited thereto. In other embodiments, the insulating layer 213b is made of nonconductive material, such as plastic. The wire 213a may be metal. To increase the conductivity, the wire 213a may be a copper coated with tin or silver, wherein a copper wire coated with silver has better conductivity.

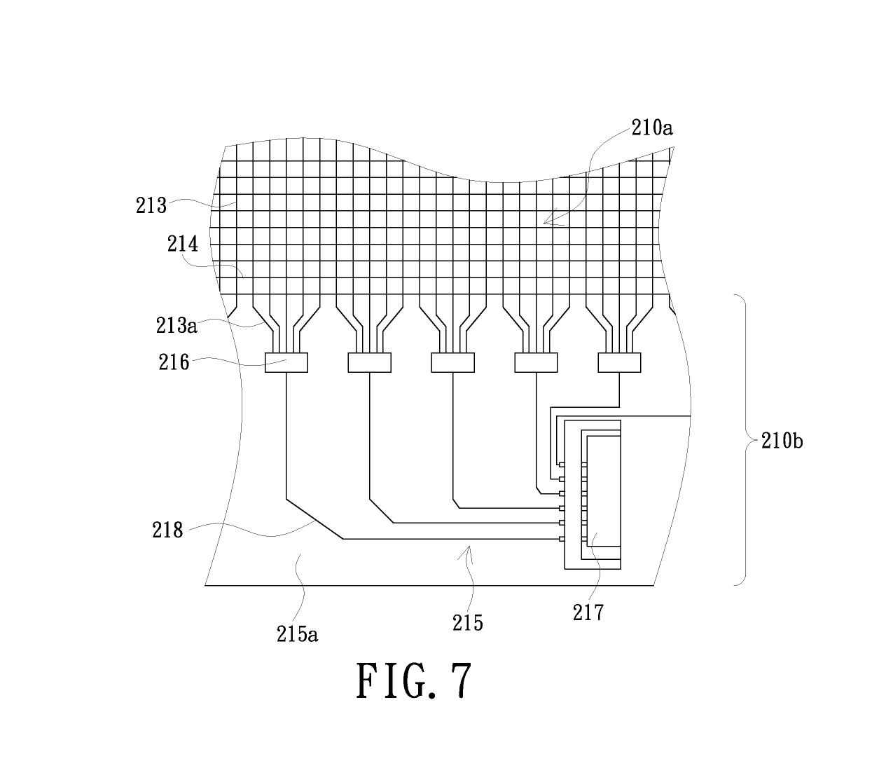

FIG. 7 is a schematic view for illustrating a connection between a circuit connection unit and wires in accordance with an embodiment of the present invention. FIG. 7 only exemplarily shows a part of the connection between the circuit connection unit 215 and the wires 213a. Please refer to FIGS. 3 and 7. In this embodiment, the circuit connection unit 215 is connected to the wires 213a in the edge area 210b. The circuit connection unit 215 includes, for instance, at least one first circuit board 215a and at least one second circuit board 215b (shown in FIG. 3). The first circuit board 215a is electrically connected to the first sensing wires 213. The second circuit board 215b is electrically connected to the second sensing wires 214 (not shown). Each of the first circuit board 215a and the second circuit board 215b includes a plurality of connection pads 216 and a plurality of connection terminals 217. The connection way between the wires 213a of the first sensing wires 213 and the first circuit board 215a is basically same as that between the wires of the second sensing wires 214 and the second circuit board 215b, thus, only the first sensing wire 213 will be taken as an example for the description of the connection between the sensing wires and the circuit board as follows. As shown in FIG. 7, in this embodiment, a plurality of wires 213a of the respective neighboring first sensing wire 213 are collected to connect to one of the connection pads 216. Each connection pad 216 is electrically connected to the corresponding connection terminal 217 via a wire 218. The connection terminal 217 may be further eclectically connected to an external electrical device (not shown), such as a computer, and for transmitting the touch sensing signals produced by the capacitive touch sensing layer 210. In this embodiment, the weaving density of the first sensing wires 213 and the second sensing wires 214 of the capacitive touch sensing layer 210 is, for instance, 10 to 40 meshes per inch; however, the invention is not limited thereto. The capacitive touch sensing layer 210 would have higher stability and less deformation with a higher weaving density of the first sensing wires 213 and the second sensing wires 214. While a user performs a touch operation by fingers, the area being touched by fingers includes a plurality of first sensing wires 213 and a plurality of second sensing wires 214. These first sensing wires 213 or these second sensing wires 214 are collected to connect to one corresponding connection pad 216, only one connection pad 216 is required for corresponding multiple first sensing wires 213 or second sensing wires 214 for transmission of the touch sensing signals instead of requiring a plurality of connection pads 216 which are correspondingly connected to each of the first sensing wires 213 and the second sensing wires 214, and consequentially the cost of the connection pads 216 is reduced.

In this embodiment, the capacitive touch sensing layer 210 is formed by weaving the first sensing wires 213 and the second sensing wires 214 with each other in grid. While the projector 100 projects an image onto the touch projection screen 200, a user can use fingers or other conductive objects to perform a touch operation on the touch projection screen 200. Specifically, when fingers or conductive objects touch or are close to the touch projection screen 200, a touch sensing signal is generated by a change of the capacitance of the capacitive touch sensing layer 210. The touch sensing signals are transmitted to the connection pads 216 through the first sensing wires 213 and the second sensing wires 214, and then are transmitted to the connection terminals 217 through the wire 218 since the wires 218 are electrically connected to the connection terminals 217. The touch sensing signals are transmitted to an external computer via the connection terminals 217 thereby obtaining the touched position on the touch projection screen 200.

In this embodiment, the touch projection screen 100 can be bent in roll and easy to carry and store due to that the capacitive touch sensing layer 210 is formed by weaving the first sensing wires 213 and the second sensing wires 214 with each other in grid, the substrate 220 is made of flexible materials, and the capacitive touch sensing layer 210 and the substrate 220 are flexible.

Moreover, because being formed by weaving the first sensing wires 213 and the second sensing wires 214 with each other in grid, the touch projection screen 200 in this embodiment doesn't need the embossing, alignment and bonding processes which are used in the conventional capacitive touch panels. Thus, compared with the conventional capacitive touch panel, the touch projection screen of the present invention has less manufacturing process and lower manufacturing cost. In addition, the first sensing wires 213 and the second sensing wires 214 located in the part of the touch sensing area 210a of the capacitive touch sensing layer 210 are coated with the insulating layers; thus, the short circuits are avoided between the intersected first sensing wires 213 and the second sensing wires 214.

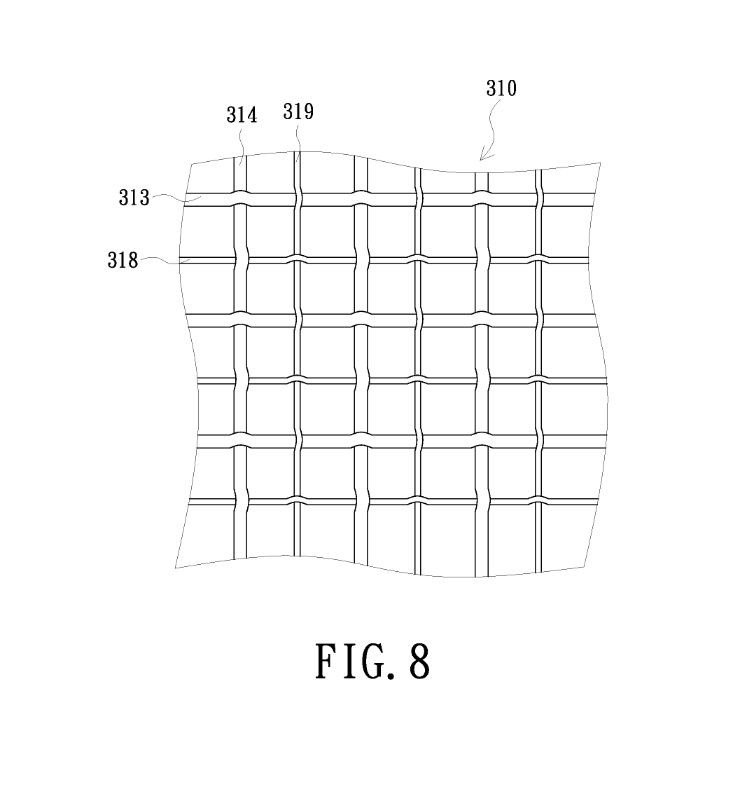

FIG. 8 is an enlarged schematic view of a part of a touch sensing area of a capacitive touch sensing layer in accordance with another embodiment of the present invention. Please refer to FIG. 8. The capacitive touch sensing layer 310 in this embodiment has a structure similar to that of the capacitive touch sensing layer 210 in FIGS. 3 and 5. The main difference between the two capacitive touch sensing layers 310 and 210 is that the capacitive touch sensing layer 310 further includes a plurality of first insulating wires 318 and a plurality of second insulating wires 319. Each first insulating wire 318 is parallel to the first sensing wires 313 and is disposed between the respective two neighboring first sensing wires 313. Each second insulating wire 319 is parallel to the second sensing wires 314 and is disposed between the respective two neighboring second sensing wires 314. The first sensing wires 313 and the second sensing wires 314 and the first insulating wires 318 and the second insulating wires 319 are arranged in grid. The first insulating wires 318 and the second insulating wires 319 are, for instance, made of plastic material; however, the present invention is not limited thereto. In FIG. 8, only one first insulating wire 318 is exemplarily shown between the respective two neighboring first sensing wires 313 and only one second insulating wire 319 is exemplarily shown between the respective two neighboring second sensing wires 314; however, the present invention is not limited to the number of the first insulating wires 318 and the second insulating wires 319. In other words, the number of the first insulating wires 318 disposed between the respective two neighboring first sensing wires 313 and the number of the second insulating wires 319 disposed between the respective two neighboring second sensing wires 314 may be zero or more than one in accordance with the requirements. In one embodiment, the number of the first insulating wires 318 disposed between the respective two neighboring first sensing wires 313 and the number of the second insulating wires 319 disposed between the respective two neighboring second sensing wires 314 may be different. In other embodiment, the number of the first insulating wires 318 and the second insulating wires 319 in the grid defined by the respective first sensing wires 313 and the second sensing wires 314 may be different from each other.

In this embodiment, because the capacitive touch sensing layer 310 further includes the first insulating wires 318 placed between each two neighboring first sensing wires 313 and the second insulating wires 319 placed between each two neighboring second sensing wires 314, the number of the first sensing wires 313 and the second sensing wires 314 can be reduced and the capacitive touch sensing layer 310 may still has certain structure stability and is not deformed easily. Furthermore, the first insulating wires 318 and the second insulating wires 319 are less expensive and consequentially the overall cost can be reduced.

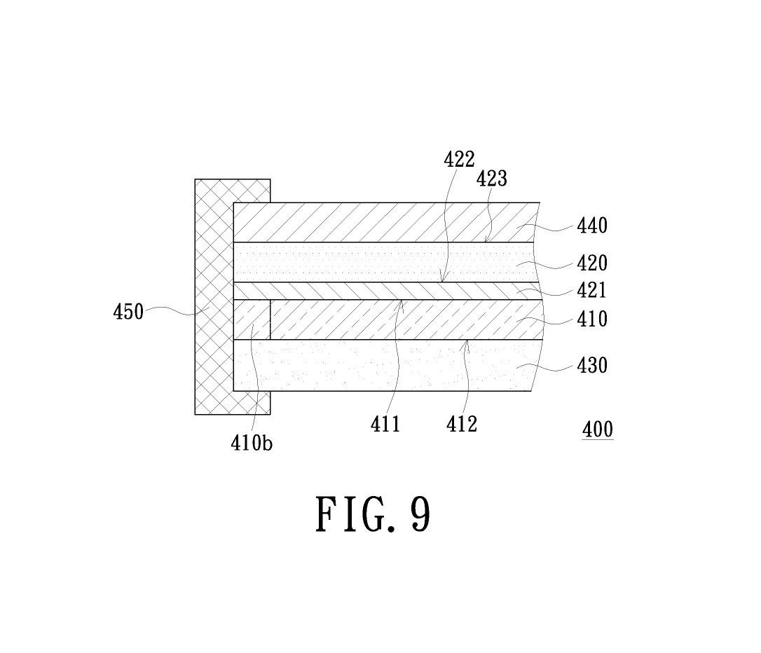

FIG. 9 is a cross-sectional view of a touch projection screen in accordance with another embodiment of the present invention. Please refer to FIG. 9. In this embodiment, the touch projection screen 400 has a structure similar to that of the touch projection screen 200. The main difference between the touch projection screen 200 and the touch projection screen 400 is that the substrate 420 of the touch projection screen 400 further includes a glue layer 421. The glue layer 421 is disposed on a third surface 422 of the substrate 420 facing to a capacitive touch sensing layer 410 and attached to a first surface 411 of the capacitive touch sensing layer 410 for adhering the substrate 420 and the capacitive touch sensing layer 410 with each other. In one embodiment, the touch projection screen 400 further includes, for instance, a protection layer 430 which covers on a second surface 412 of the capacitive touch sensing layer 410 opposite to the substrate 420. The protection layer 430 is used to prevent the abrasion of the insulating layers of the first sensing wires and the second sensing wires when the capacitive touch sensing layer 410 is being rolled and carried. It is understood that if the insulating layers of the first sensing wires and the second sensing wires get abrasion, the exposed wires may cause a short circuit which may affect the touch sensing function of the capacitive touch sensing layer 410. The protection layer 430 is, for instance, made of flexible plastic or other material thereby being able to roll with the capacitive touch sensing layer 410 and the substrate 420; however, the present invention is not limited thereto. The touch projection screen 400 in this embodiment further includes, for instance, a translucent layer or transparent layer 440 which covers on a surface 423 of the substrate 420 opposite to the capacitive touch sensing layer 410. The translucent layer or transparent layer 440 is, for instance, a translucent or transparent plastic sheet or made of other flexible materials for achieving the effect of protecting the substrate 420 without affecting the image projected on the substrate 420.

As shown in FIG. 9, the touch projection screen 400 in this embodiment may further include a case 450. The case 450 at least covers an edge area 410b of the capacitive touch sensing layer 410, a circuit connection unit (not shown) and the partial substrate 420. The case 450 in this embodiment covers, for instance, the edge area 410b of the capacitive touch sensing layer 410, the circuit connection unit (not shown), the partial substrate 420, the partial protection layer 430 and the partial translucent layer (or transparent layer) 440. The case 450 is configured to support the touch projection screen 400 to maintain the touch projection screen 400 flat when being used for projection, so as to prevent the touch projection screen 400 from being curly which may affect the quality of projection image on the touch projection screen 400.

In summary, the first sensing wires and the second sensing wires are arranged in grid in the capacitive touch sensing layer of the touch projection screen and the wires of the first sensing wires and the second sensing wires located in the touch sensing area are coated by the insulating layers; thus, the short circuits are avoided between the first sensing wires and the second sensing wires. Compared with the conventional capacitive touch panel, the touch projection screen of embodiments of the invention does not need the embossing, alignment and bonding processes which are used in the conventional capacitive touch panel, and accordingly has less manufacturing process. Furthermore, compared with the conventional capacitive touch panel by using the ITO circuits, the touch projection screen of the present invention by using wires coated with insulating layers has lower cost. Thus, the projection system of the present invention has less manufacturing process and lower cost by using the aforementioned touch projection screen.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A touch projection screen, comprising:
a capacitive touch sensing layer, comprising a first surface, a second surface opposite to the first surface, a plurality of first sensing wires, a plurality of second sensing wires and at least one circuit connection unit; and
a substrate, covering on the first surface,
wherein any two of the first sensing wires do not intersect with each other, any two of the second sensing wires do not intersect with each other, the first sensing wires and the second sensing wires are alternatively arranged in grid to define a touch sensing area and an edge area is around at least part of the touch sensing area, each of the first sensing wires and the second sensing wires includes a wire and an insulating layer, and the insulating layer covers the part of the wire located in the touch sensing area,
and wherein the at least one circuit connection unit is electrically connected to the wires in the edge area.

2. The touch projection screen according to claim 1, wherein the capacitive touch sensing layer further comprises a plurality of first insulating wires and a plurality of second insulating wires, the first insulating wires are parallel to the first sensing wires and the second insulating wires are parallel to the second sensing wires, each of the first insulating wires is disposed between the respective two neighboring first sensing wires, and each of the second insulating wires is disposed between the respective two neighboring second sensing wires, wherein the first insulating wires, the second insulating wires, the first sensing wires, and the second sensing wires are alternatively arranged in grid.

3. The touch projection screen according to claim 1, wherein each connection unit comprises at least one first circuit board which is electrically connected to the first sensing wires, and at least one second circuit board which is electrically connected to the second sensing wires.

4. The touch projection screen according to claim 3, wherein each of the first circuit board and the second circuit board comprises a plurality of connection pads and a connection terminal, a first end of each connection pad is electrically connected to the respective neighboring wires and a second end thereof is electrically connected to the respective connection terminal.

5. The touch projection screen according to claim 1, wherein the substrate is a white reflection sheet.

6. The touch projection screen according to claim 1, wherein the substrate comprises a glue layer attached to the first surface of the capacitive touch sensing layer.

7. The touch projection screen according to claim 1, further comprising a protection layer covering on the second surface of the capacitive touch sensing layer.

8. The touch projection screen according to claim 1, further comprising a translucent layer or a transparent layer covering on a surface of the substrate opposite to the capacitive touch sensing layer.

9. The touch projection screen according to claim 1, further comprising a case at least covering the edge area of the capacitive touch sensing layer, the circuit connection unit and a part of the substrate.

10. The touch projection screen according to claim 1, wherein the capacitive touch sensing layer and the substrate are flexible.

11. A projection system, comprising:
a touch projection screen; and
a projection device, configured to project an image onto the touch projection screen
wherein the touch projection screen comprises:
a capacitive touch sensing layer, comprising a first surface, a second surface opposite to the first surface, a plurality of first sensing wires, a plurality of second sensing wires and at least one circuit connection unit; and
a substrate, covering on the first surface,
wherein any two of the first sensing wires do not intersect with each other, any two of the second sensing wires do not intersect with each other, the first sensing wires and the second sensing wires are alternatively arranged in grid to define a touch sensing area and an edge area is around at least part of the touch sensing area, each of the first sensing wires and the second sensing wires includes a wire and an insulating layer, and the insulating layer covers the part of the wire which is located in the touch sensing area, and
wherein the at least one circuit connection unit is electrically connected to the wires in the edge area.

12. The projection system according to claim 11, wherein the capacitive touch sensing layer further comprises a plurality of first insulating wires and a plurality of second insulating wires, the first insulating wires are parallel to the first sensing wires and the second insulating wires are parallel to the second sensing wires, each of the first insulating wires is disposed between the respective two neighboring first sensing wires, and each of the second insulating wires is disposed between the respective two neighboring second sensing wires, wherein the first insulating wires, the second insulating wires, the first sensing wires, and the second sensing wires are alternatively arranged in grid.

13. The projection system according to claim 11, wherein each connection unit comprises at least one first circuit board which is electrically connected to the first sensing wires, and at least one second circuit board which is electrically connected to the second sensing wires.

14. The projection system according to claim 13, wherein each of the first circuit board and the second circuit board comprises a plurality of connection pads and a connection terminal, a first end of each connection pad is electrically connected to the respective neighboring wires and a second end thereof is electrically connected to the respective connection terminal.

15. The projection system according to claim 11, wherein the substrate is a white reflection sheet.

16. The projection system according to claim 11, wherein the substrate comprises a glue layer attached to the first surface of the capacitive touch sensing layer.

17. The projection system according to claim 11, further comprising a protection layer covering on the second surface of the capacitive touch sensing layer.

18. The projection system according to claim 11, further comprising a translucent layer or a transparent layer covering on a surface of the substrate opposite to the capacitive touch sensing layer.

19. The projection system according to claim 11, further comprising a case at least covering the edge area of the capacitive touch sensing layer, the circuit connection unit and a part of the substrate.

20. The projection system according to claim 11, wherein the capacitive touch sensing layer and the substrate are flexible.
